(19) United States
(12) Patent Application Publication
(10) Pub. No.: US 2021/0130022 A1
(43) Pub. Date: May 6, 2021

(54) Apparatus and Method for Determining the Existence of a Pressure Differential between the Interior and Exterior of a Sealed Bundle of Tobacco Industry Products

(71) Applicant: British American Tobacco (Investments) Limited, London (GB)

(72) Inventors: Steven HOLFORD, London (GB); Andrew Jonathan BRAY, London (GB); Jeonghwan PARK, London (GB)

(21) Appl. No.: 16/638,826

(22) PCT Filed: Aug. 8, 2018
(86) PCT No.: PCT/GB2018/052261

§ 371 Date: Feb. 13, 2020

(30) Foreign Application Priority Data
Aug. 17, 2017 (GB) 1713219.2

(51) Int. Cl. B65B 57/00; G01M 3/32; G01M 3/36; B65B 19/22; B65B 31/04

(52) U.S. Cl. CPC B65B 57/00; G01M 3/3272; B65B 31/04; B65B 19/22; G01M 3/36

(57) ABSTRACT

An apparatus and method for determining if a pressure differential exists between the interior and exterior of a wrapped and sealed bundle of tobacco industry products. The wrapped and sealed bundle has a barrier layer that deflects when a pressure differential is applied and the apparatus comprises a sensor operable to detect that deflection.

### FIELD OF THE INVENTION

This invention relates to an apparatus for determining if a pressure differential exists between the interior and exterior of a wrapped and sealed bundled of tobacco industry products, such as smoking articles. The invention also relates to a tobacco industry package manufacturing machine comprising such an apparatus, and to a method of determining the existence of a pressure differential between the interior and exterior of a wrapped and sealed bundle of tobacco industry products.

### BACKGROUND

It is known to provide a charge of tobacco industry products, such as smoking articles. The charge is wrapped in a layer of barrier material to form a sealed bundle prior to insertion of the bundle into an outer carton to form, for example, a hinged-lid type of smoking article pack. The barrier layer is made from a flexible, substantially gas impermeable material. To access the smoking articles, it is known to provide the barrier layer with an access aperture which is sealed by a peelable label. In some packs, the label may repositioned to reseal the bundle after first opening to maintain freshness of the smoking articles remaining in the pack.

It is also known to provide a wrapped and sealed bundle of smoking articles with a pressure differential between the interior and exterior of the wrapped bundle. In particular, it is known to provide the interior of a wrapped bundle with a reduced pressure or a partial vacuum relative to the exterior of the bundle to prevent the smoking articles from deteriorating prior to first opening due to, for example, reaction with oxygen in the atmosphere. Alternatively, a wrapped bundle may be pressurised with an inert gas that offers increased protection against deterioration of the smoking articles prior to first opening. The shelf-life of the smoking articles may thereby be increased and freshness maintained. In addition to preserving freshness and flavour, a rush of ambient air into the bundle upon first opening may provide an audible indicator, such as a ‘hiss’, to the consumer which signifies that the bundle is fresh and has not previously been opened.

To apply a pressure differential, the wrapped bundle may include a valve through which the nozzle of a pressure generator may be inserted once the barrier layer has been sealed during the manufacturing process. The valve may be configured to self-close upon withdrawal of the nozzle so that the pressure differential is maintained until the bundle is first opened by removing or peeling back the label extending over the access aperture.

The present invention seeks to provide apparatus for determining if a pressure differential exists between the interior and exterior of a wrapped and sealed bundle of tobacco industry products, to a tobacco industry package manufacturing machine having such an apparatus and, to a method of determining if a pressure differential exists between the interior and exterior of a wrapped and sealed bundle of tobacco industry products.

### SUMMARY

According to an aspect of the present invention, there is provided an apparatus for determining if a pressure differential exists between the interior and exterior of a wrapped and sealed bundle of tobacco industry products having a barrier layer that deflects on application of a pressure differential, the apparatus comprising a sensor operable to detect deflection of the barrier layer.

The apparatus may comprise a controller to control a pressure generator that applies the pressure differential, the sensor being configured to generate a signal indicative of deflection of the barrier layer and to supply the signal to the controller.

The signal may be indicative of an extent to which the barrier layer has been deflected.

The controller may be operable to deactivate the pressure generator when the extent of deflection of the barrier layer equals or exceeds a target or threshold deflection.

The extent of deflection of the barrier layer may be a distance between a datum and the deflected barrier layer, the target deflection being a target distance between the datum and the deflected barrier layer.

The sensor may be operable to determine the distance between the datum and the deflected barrier layer multiple times at different locations across the deflected barrier layer and to calculate an average distance between the datum and deflected barrier layer, the controller being operable to deactivate the pressure generator when the calculated average distance equals or exceeds the target distance.

The sensor may comprise a light source and a receiver for detecting reflected light emitted by the light source. The distance between the datum and the barrier layer may be determined based on a comparison between the time taken for light reflected by the datum to be detected by the receiver compared to the time taken for light reflected by the deflected barrier layer to be detected by the receiver.

The sensor may comprise a laser distance meter configured to emit pulses of laser light and measure the time taken for reflected pulses to return.

According to another aspect of the invention, there is provided a tobacco industry package manufacturing machine comprising a wrapping station for wrapping and sealing a barrier layer around a charge of tobacco industry products to form a wrapped and sealed bundle of tobacco industry products, a pressure generator for generating a pressure differential between the interior and exterior of the wrapped bundle so that the barrier layer deflects, the tobacco industry package manufacturing machine further comprising the apparatus according to any one of the preceding claims for determining if a pressure differential exists between the interior and exterior of the wrapped and sealed bundle during application of a pressure differential by the pressure generator.

According to a further aspect of the invention, there is provided a tobacco industry package manufacturing machine comprising a wrapping station for wrapping and sealing a barrier layer around a charge of tobacco industry products to form a wrapped and sealed bundle of tobacco industry products, a pressure generator for generating a pressure differential between the interior and exterior of the wrapped bundle so that the barrier layer deflects, the tobacco industry package manufacturing machine further comprising apparatus for determining if a pressure differential exists between the interior and exterior of the wrapped and sealed bundle of tobacco industry products, the apparatus comprising a sensor operable to detect deflection of the barrier layer, wherein the apparatus for determining if a pressure differential exists is remote from the pressure generator so that deflection of the barrier layer is detected after a pressure differential has been applied to the wrapped and sealed bundle of smoking articles.

The tobacco industry package manufacturing machine may comprise a carriage to transport a bundle of smoking articles wrapped in a layer of barrier material through the tobacco industry package manufacturing machine. The carriage may comprise an aperture or opening through which the layer of barrier material is exposed and which is deflected when a pressure differential is applied.

The sensor may be configured to detect deflection of the exposed layer of barrier material through the aperture in the carriage.

An extent of deflection of the barrier layer may be measured as a distance between a datum and the exposed layer of barrier material through the aperture in the carriage. The datum may comprise a surface on the carriage adjacent to the aperture in the carriage.

The pressure generator may be configured to generate a vacuum pressure in the wrapped and sealed bundle so that the barrier layer deflects against the charge of smoking articles wrapped by the barrier layer.

According to another aspect of the invention, there is provided a tobacco industry package handling machine comprising the apparatus according to the invention.

According to another aspect of the invention, there is provided a method of determining if a pressure differential exists between the interior and exterior of a wrapped and sealed bundle of tobacco industry products that comprises a barrier layer which deflects in response to the presence of a pressure differential, the method comprising using a sensor to detect deflection of the barrier layer.

The method may comprise supplying a signal indicative of the extent of deflection of the barrier layer to a controller for controlling a pressure generator that generates the pressure differential in said wrapped and sealed bundle of smoking articles.

The method may include determining the extent of deflection of the barrier layer.

A determination of the extent of deflection of the barrier layer may be achieved by determining a distance between a datum and the deflected layer of barrier material.

The method may include deactivating the pressure generator when the determined distance between the datum and the deflected barrier layer equals or exceeds a target distance.

### BRIEF DESCRIPTION OF THE DRAWINGS

Embodiments of the invention will now be described, by way of example only, with reference to the accompanying drawings, in which:

FIG. 1 shows a front perspective view of a bundle comprising a charge of tobacco industry products wrapped and sealed in a barrier layer that incorporates a valve to facilitate the application of a pressure differential between the interior and exterior of the bundle;

FIG. 2 shows a wrapped and sealed bundle of tobacco industry products held by a carriage for transportation of the wrapped bundle through a tobacco industry package manufacturing machine;

FIG. 3A shows a schematic illustration of a tobacco industry package manufacturing machine according to an embodiment of the invention, which also includes apparatus for determining if a pressure differential exists between the interior and exterior of a wrapped and sealed bundle of tobacco industry products, in which the wrapped and sealed bundle held by a carriage as shown in FIG. 2, is shown approaching a point at which a pressure differential is to be generated across the barrier layer;

FIG. 3B shows the tobacco industry package manufacturing machine of FIG. 3A in which air is being withdrawn from the wrapped and sealed bundle held by the carriage.

### DETAILED DESCRIPTION

It is known to provide a wrapped and sealed bundle of smoking articles with a pressure differential between the interior and exterior of the bundle. However, it is difficult to determine with any certainty whether a pressure differential has been achieved or, whether an intended pressure differential has been met or exceeded. This can result in bundles not being pressurised correctly, or not being pressurised at all. Embodiments of the present invention seek to address this issue and to provide a reliable apparatus and method for determining the existence of a pressure differential and, in certain embodiments, controlling a pressure generator to achieve a desired pressure differential.

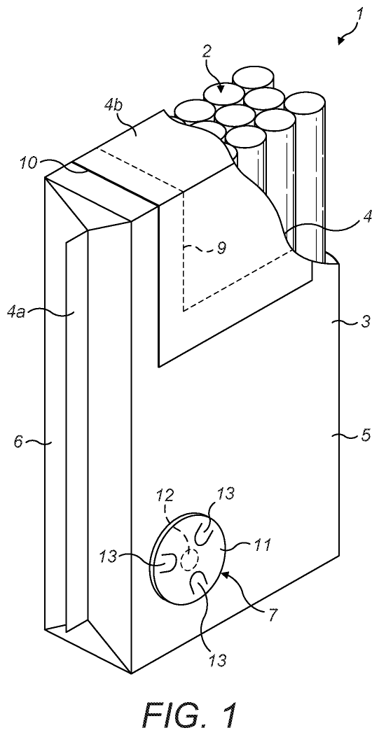

FIG. 1 shows a bundle 1 comprising a charge 2 of tobacco industry products, in this case smoking articles, overwrapped in a barrier layer 4. For illustration purposes only, a part of the barrier layer 4 has been removed in FIG. 1 so that the charge of smoking articles 2 can be seen. During manufacture of the bundle 1, the barrier layer 4 is sealed around the charge of smoking articles 2 to form an air-tight enclosure. When the barrier layer 4 is wrapped about the charge 2, it has a pair of parallel major surfaces 5 spaced from each other by narrower side surfaces 6. Edges 4a of the barrier layer 4 overlap at the side surfaces 6 and are joined using a conventional fin-sealing process.

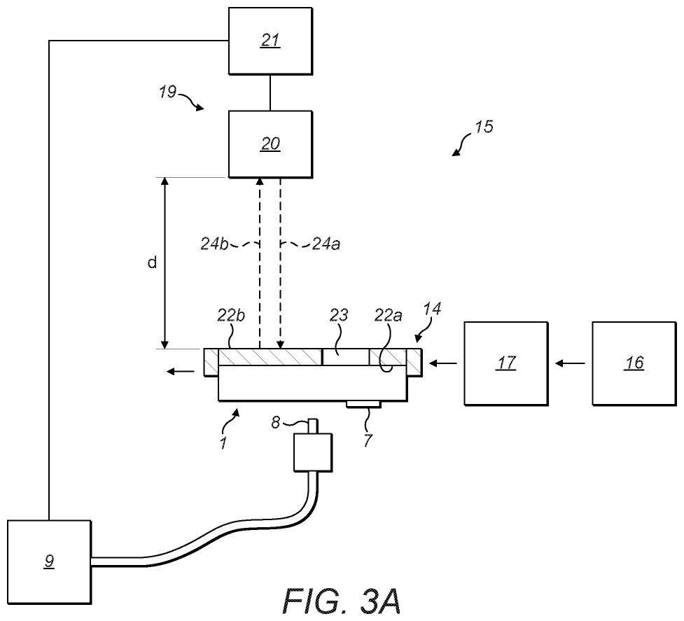

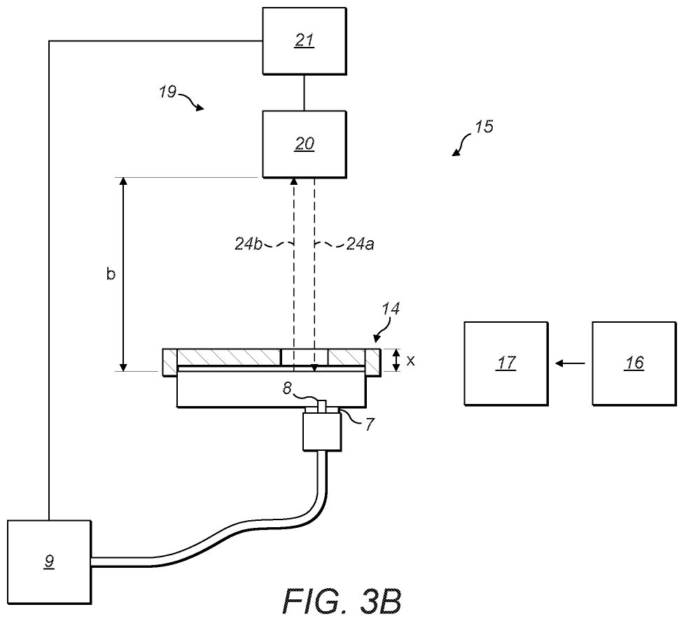

A one-way valve 7 is incorporated into one of the major surfaces 5 of the barrier layer 4. A nozzle 8 (see FIGS. 3a and 3b) of a pressure generator 9 may be temporarily coupled to to the one-way valve 7 to allow air to be, most preferably, drawn out of the bundle 1 to establish a negative pressure or partial vacuum within the bundle 1. Alternatively, the bundle 1 may be pressurised by forcing an inert gas into the bundle 1 through the one-way valve 7. The one-way valve 7 is designed to prevent the flow of air or gas through it when the nozzle 8 is not coupled to it, so that the generated pressure differential between the interior and exterior of the bundle 1 is maintained after the nozzle 8 has been detached from the one-way valve 7.

To enable a consumer to access the smoking articles 2, the barrier layer 4 is provided with a separable section 4b. As shown by the dashed lines in FIG. 1, the separable section 4b is delimited by a line of weakness 9, such as perforations formed in barrier layer 4, which break upon first opening of the bundle 1. A re-sealable cover flap or label 10 extends over the separable section 4b and beyond the line of weakness 9. The re-sealable label 10 is coated with pressure sensitive adhesive and seals against the barrier layer 4 so that a loss of the pressure differential via the line of weakness 9 is prevented until the label 10 is lifted and the line of weakness 9 broken. It will be appreciated that, as the line of weakness 9 may extend only partially through the thickness of the barrier layer 4, the label 10 does not need to maintain the air-tightness of the bundle 1 prior to first opening. The label 10 is adhered to the barrier layer 4 so that, when it is peeled back, the line of weakness 9 between the separable section 4a and the barrier layer 4 is broken and the separable section 4a lifts together with the label 10 to provide an access aperture in the barrier layer 4. It will be appreciated that only when the line of weakness 9 breaks will the pressure between the interior and exterior of the bundle 1 be equalized.

With reference to the embodiment shown in FIG. 1, the one-way valve 7 comprises a pad 11 bonded around its perimeter over a small aperture 12 in the barrier layer 4. The pad 11 includes moveable flaps 13 that rest against the surface of the barrier layer 4 beneath the pad 11. When a vacuum source is applied to the pad 11 via the pressure generator 9, as illustrated in FIG. 3B, air is drawn from within the bundle 1 through the small aperture 12, and the flaps 13 lift away from the barrier layer 4 slightly to allow the air to exit the bundle 1. As air is withdrawn from the bundle 1, the pressure drop causes the barrier material 4 to be sucked inwardly so that it conforms more closely to the shape of the charge 2. Once the vacuum source is removed, the negative pressure generated within the bundle 1 pulls the flaps 13 tight against the underlying barrier layer 4 to form a seal, thereby preventing air from passing back into the bundle 1 through the aperture 12. The bundle 1 is sufficiently sealed so that the reduced pressure is maintained within the bundle 1 until it is opened for the first time by lifting the re-sealable label 10 to break the line of weakness 9.

The barrier layer 4 is made from a substantially gas-impermeable, flexible, material and may, in particular, be impermeable to oxygen to prevent ingress of oxygen into the bundle 1. The gas-impermeable material of the barrier layer 4 prevents the transmission of moisture through the barrier material 4, so the moisture content within the bundle 1 remains constant and is not affected by external conditions.

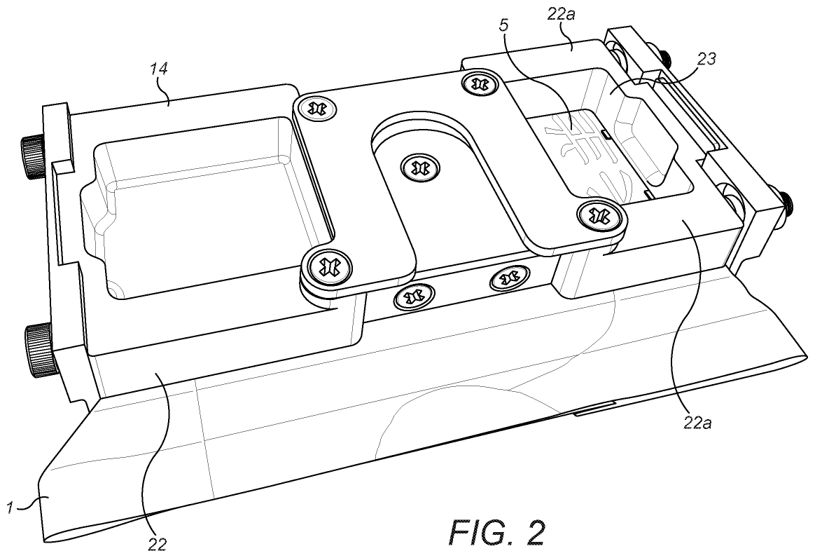

With reference to FIG. 2, a bundle 1 is shown attached to a cradle or carriage 14. The carriage 14 conveys the bundle 1 through a tobacco industry package manufacturing machine 15, as shown schematically in FIGS. 3A and 3B.

The tobacco industry package manufacturing machine 15 may include a combining station 16 for combining individual smoking articles into groups to form the charge 2 of smoking articles 2, a wrapping station 17 for wrapping and sealing the barrier layer 4 around the charge 2, and the pressure generator 9 for generating a pressure differential across the barrier layer 4 of the wrapped and sealed bundle 1. As the combining station 16, the wrapping station 17 and the pressure generator 18 are conventional, they have been represented only by boxes in FIGS. 3a and 3b.

In another embodiment, the apparatus according to embodiments of the invention may be part of a tobacco industry package handling machine. For example, a machine which is not directly involved in the actual manufacture of the tobacco industry packages, but which transports or otherwise handles the packages post manufacture.

As also shown in FIGS. 3A and 3B, the tobacco industry package manufacturing machine 15, according to an embodiment of the invention, includes apparatus 19 for determining if a pressure differential exists between the interior and exterior of the wrapped and sealed bundle 1 which has been manufactured, and which has had a pressure differential applied to it, by the machine 15. In particular, the apparatus 19 for determining if a pressure differential exists is preferably positioned so that the determination may be made whilst the bundle 1 is connected to the pressure generator 18 and whilst a pressure differential is being generated, as will be explained in more detail below. However, it is also envisaged that in other embodiments, the apparatus 19 for determining the existence of a pressure differential between the interior and exterior of a wrapped and sealed bundle 1 may be located remotely so that it is separated from the tobacco industry package manufacturing machine 15 and so the determination occurs only after a pressure differential has been generated. In particular, the apparatus 19 for determining the existence of a pressure differential may be located downstream of the machine 15, so that a determination of the existence of a pressure differential is made only after a bundle 1 has been uncoupled from the pressure generator 9.

In each embodiment of the invention, the apparatus for determining if a pressure differential exists comprises a sensor 20. In embodiments in which a determination is made only after a bundle 1 has been manufactured and a pressure differential applied, the sensor 20 may generate a signal indicative of whether a pressure differential has been generated in a bundle 1 and, preferably, the extent of that pressure differential. If the signal is indicative of a pressure differential not being present or not being sufficient, a controller 21 may be responsive to the signal to reject the bundle 1 by, for example, sending it along a reject path different to the path along which bundles 1 having a pressure differential or, the required pressure differential, are sent, to separate those bundles 1 having a pressure differential from those that do not. It is envisaged that, in its simplest form, the apparatus 19 of the invention will be capable only of detecting the occurrence of a deflection of a surface of the barrier material 4, without making any determination as to the extent of that deflection. The existence of a deflection is sufficient to indicate that a pressure differential has been generated, even if the extent of that pressure differential remains unknown. Preferably, however, the apparatus 19 is configured to determine not only the presence of a pressure differential, but also the extent of that pressure differential, to provide an indication as to whether a sufficient or predetermined pressure differential is present.

With reference to FIG. 2, the carriage 14 includes a plate 22 having a lower surface 22a that extends across one of the major surfaces 5 of the bundle 1 opposite to the major surface in which the one-way valve 7 is formed. In the absence of a pressure differential in the bundle 1, the major surface 5 over which the plate 22 extends lies close to, or in contact with, the lower surface 22a. The plate 22 has an opening 23 through which a portion of the major surface 5 of the barrier layer 4 is visible and an upper surface 22b.

The sensor 20 incorporates a light source and a receiver (not shown). Preferably, the sensor 20 comprises a laser distance meter, a range finder, or a camera, the use of which is known for determining distance. A laser distance meter or range finder emits pulses 24a of laser light and measures the time taken for the reflected pulses 24b to return.

When the carriage 14 moves beneath the sensor 20, either in the tobacco industry package manufacturing machine 15, as shown in FIG. 3A, or at a remote location, pulses of laser light 24a are emitted by the laser distance meter towards the carriage 14 and the bundle 1 held thereby. As the carriage 14 travels beneath the sensor 20, the laser 24a is initially incident on the upper surface 22b of the carriage 14 adjacent to the opening 23. This upper surface 22b is a datum surface from which deflection of the major surface 5 is measured. Although it is preferable that the datum surface 22b is on the carriage 14, it is also possible for the datum surface to be on a part of the tobacco industry package manufacturing machine 15 or another location.

With input from the controller 21, the sensor 20 is operable to calculate the distance (“d” in FIG. 3A) between the sensor 20 and the upper datum surface 22b. This datum distance “d” provides a measurement from which deflection of the upper surface 5 of the barrier layer 4 can be determined.

The carriage 14 then moves so that pulses of laser light 24a are incident on that portion of the barrier layer 4 which is visible through the opening 23 in the carriage 14, as shown in FIG. 3B. The sensor 20 is now operable to calculate the distance to bundle 1 (“b” in FIG. 3B) between the sensor 20 and the upper surface 5 of the barrier layer 4. By substracting the distance “d” from the distance “b”, the distance (“x” in FIG. 1) from the datum surface 22a to the surface of the bundle 1 is determined prior to the generation of any pressure differential between the interior and exterior of the bundle 1.

Next, the nozzle 8 of the pressure generator 9 is coupled to the one-way valve 7 and the pressure generator 9 is activated to withdraw air from the bundle 1. The sensor 20 records the change in distance “x” that occurs as a result of deflection of the major surface 5 of the bundle 1. Preferably, the sensor 20 records the deflection of major surface 5 in real time so that, when a predetermined or target deflection has been reached, a signal is generated by the controller 21 and the pressure generator 9 is stopped.

Subject to manufacturing tolerances, it is envisaged that, in some embodiments, the distance “x” from the datum to the major surface 5 of the bundle 1 prior to the application of the vacuum will be about 10 mm, and that application of the vacuum will be stopped when the distance “x” has increased to 10.2 mm, representing a target deflection of the major surface 5 of the bundle 1 of about 0.2 mm.

It will be appreciated that the predetermined deflection is related to the pressure differential within the bundle 1, and the relationship between deflection and pressure differential may be ascertained beforehand for a particular type of bundle and materials. For example, it may be established that, to provide a partial vacuum of 500 millibar, a deflection of the barrier layer 4 of 0.2 mm is required. By way of example, the partial vacuum within the evacuated bundle 1 may have a pressure of less than 1 bar. In some examples, the partial vacuum is less than 500 millibar, for example between 40 and 300 millibar. In other embodiments, the partial vacuum is less than 150 millibar, preferably about 80 millibar. However, it will be appreciated that the partial vacuum within the bundle 1 may be any value less than 1 bar. In other embodiments, the bundle 1 may be filled with an inert gas at an elevated pressure. The valve 7 may enable filling and, optionally, also evacuation of air within the bundle 1 before filling.

It will be understood that the sensor 20 may be operable to determine the distance “x” between the datum surface 22b and the major surface 5 of the deflected barrier layer 4 multiple times at different locations across that portion of the major surface 5 which is visible to the sensor 20 through the aperture 23 in the plate 22. The controller 21 may then be operable to calculate an average distance for “x” between the datum surface 22b and the major surface 5. In this case, the controller 21 may be operable to deactivate the pressure generator 9 when the calculated average distance equals or exceeds the target distance.

As used herein, the term “tobacco industry product” is intended to include smoking articles comprising combustible smoking articles such as cigarettes, cigarillos, cigars, tobacco for pipes or for roll-your-own cigarettes, (whether based on tobacco, tobacco derivatives, expanded tobacco, reconstituted tobacco, tobacco substitutes or other smokable material), electronic smoking articles such as e-cigarettes, heating devices that release compounds from substrate materials without burning such as tobacco heating products, hybrid systems to generate aerosol from a combination of substrate materials, for example hybrid systems containing a liquid or gel or solid substrate; and aerosol-free nicotine delivery articles such as lozenges, gums, patches, articles comprising breathable powders and smokeless tobacco products such as snus and snuff.

In some embodiments, the tobacco industry product is a non-combustible smoking article. In some embodiment the tobacco industry product is a heating device which releases compounds by heating, but not burning, a substrate material. The material may be for example tobacco or other non-tobacco products, which may or may not contain nicotine. In some embodiments the heating device is a tobacco heating device.

In other embodiments the tobacco industry product is a hybrid system to generate aerosol by heating, but not burning, a combination of substrate materials. The substrate materials may comprise for example solid, liquid or gel which may or may not contain nicotine. In some embodiments, the hybrid system comprises a liquid or gel substrate and a solid substrate. The solid substrate may be for example tobacco or other non-tobacco products, which may or may not contain nicotine. In some embodiments the hybrid system comprises a liquid or gel substrate and tobacco.

As used herein, the term “partial vacuum” means that pressure has been reduced relative to local atmospheric pressure, i.e. the pressure exterior of the bundle 1, by removing at least a part of the gas from within a space, for example the enclosure within the barrier material 4 of the wrapped and sealed bundle 1.

In order to address various issues and advance the art, the entirety of this disclosure shows by way of illustration various embodiments in which the claimed invention(s) may be practiced and provide for superior apparatus, a tobacco industry package manufacturing machine, a tobacco industry package handling machine, a method for manufacturing a tobacco industry package, and a method of determining if a pressure differential exists between the interior and exterior of a wrapped and sealed bundle of tobacco industry products. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. Apparatus for determining if a pressure differential exists between the interior and exterior of a wrapped and sealed bundle of tobacco industry products having a barrier layer that deflects on application of such a pressure differential, the apparatus comprising a sensor operable to detect deflection of the barrier layer.

2. Apparatus according to claim 1, comprising a controller to control a pressure generator that applies the pressure differential, the sensor being configured to generate a signal indicative of deflection of the barrier layer and to supply the signal to the controller.

3. Apparatus according to claim 2, wherein the signal is indicative of an extent of deflection of the barrier layer.

4. Apparatus according to claim 3, wherein the controller is operable to deactivate the pressure generator when the extent of deflection of the barrier layer equals or exceeds a target deflection.

5. Apparatus according to claim 4, wherein the extent of deflection of the barrier layer is a distance between a datum and the deflected barrier layer, the target deflection being a target distance between the datum and the deflected barrier layer.

6. Apparatus according to claim 5, wherein the sensor is operable to determine the distance between the datum and the deflected barrier layer multiple times at different locations across the deflected barrier layer and to calculate an average distance between the datum and deflected barrier layer, the controller being operable to deactivate the pressure generator when the calculated average distance equals or exceeds the target distance.

7. Apparatus according to claim 1, wherein the sensor comprises a light source and a receiver for detecting reflected light emitted by the light source.

8. Apparatus according to claim 5, wherein the sensor comprises a light source and a receiver for detecting reflected light emitted by the light source, wherein the distance between the datum and the barrier layer is determined based on a comparison between the time taken for light reflected by the datum to be detected by the receiver compared to the time taken for light reflected by the deflected barrier layer to be detected by the receiver.

9. Apparatus according to claim 7, wherein the sensor comprises a laser distance meter configured to emit pulses of laser light and measure the time taken for reflected pulses to return.

10. A tobacco industry package manufacturing machine comprising a wrapping station for wrapping and sealing a barrier layer around a charge of tobacco industry products to form a wrapped and sealed bundle of tobacco industry products, a pressure generator for generating a pressure differential between the interior and exterior of the wrapped bundle so that the barrier layer deflects, the tobacco industry package manufacturing machine further comprising the apparatus according to any one of the preceding claims for determining if a pressure differential exists between the interior and exterior of the wrapped and sealed bundle during application of a pressure differential by the pressure generator.

11. A tobacco industry package manufacturing machine comprising a wrapping station for wrapping and sealing a barrier layer around a charge of tobacco industry products to form a wrapped and sealed bundle of tobacco industry products, a pressure generator for generating a pressure differential between the interior and exterior of the wrapped bundle so that the barrier layer deflects, the tobacco industry package manufacturing machine further comprising apparatus for determining if a pressure differential exists between the interior and exterior of the wrapped and sealed bundle of tobacco industry products, the apparatus comprising a sensor operable to detect deflection of the barrier layer, wherein the apparatus for determining if a pressure differential exists is remote from the pressure generator so that deflection of the barrier layer is detected after a pressure differential has been applied to the wrapped and sealed bundle of tobacco industry products.

12. A tobacco industry package manufacturing machine according to claim 10, comprising a carriage to transport a bundle of tobacco industry products wrapped in a layer of barrier material through the tobacco industry package manufacturing machine, wherein the carriage comprises an aperture to expose the layer of barrier material which is deflected when a pressure differential is applied.

13. A tobacco industry package manufacturing machine according to claim 12, wherein the sensor is configured to detect deflection of the exposed layer of barrier material through the aperture in the carriage.

14. A tobacco industry package manufacturing machine according to claim 13, wherein an extent of deflection of the barrier layer is measured as a distance between a datum and the exposed layer of barrier material through the aperture in the carriage.

15. A tobacco industry package manufacturing machine according to claim 14, wherein the datum comprises a surface on the carriage adjacent to the aperture in the carriage.

16. A tobacco industry package manufacturing machine according to claim 10, wherein the pressure generator is configured to generate a vacuum pressure in the wrapped and sealed bundle so that the barrier layer deflects against the charge of tobacco industry products wrapped by the barrier layer.

17. A tobacco industry package handling machine comprising the apparatus for determining if a pressure differential exists between the interior and exterior of a wrapped and sealed bundle of tobacco industry products having a barrier layer that deflects on application of such a pressure differential, the apparatus comprising a sensor operable to detect deflection of the barrier layer.

18. A method of determining if a pressure differential exists between the interior and exterior of a wrapped and sealed bundle of tobacco industry products that comprises a barrier layer which deflects in response to the presence of a pressure differential, the method comprising using a sensor to detect deflection of the barrier layer.

19. A method according to claim 18, comprising supplying a signal indicative of the extent of deflection of the barrier layer to a controller for controlling a pressure generator that generates the pressure differential in said wrapped and sealed bundle of tobacco industry products.

20. A method according to claim 18, comprising determining the extent of deflection of the barrier layer.

21. A method according to claim 20, comprising determining the extent of deflection of the barrier layer by determining a distance between a datum and the deflected layer of barrier material.

22. A method according to claim 21, when dependent on claim 20, comprising deactivating the pressure generator when the determined distance between the datum and the deflected barrier layer equals or exceeds a target distance.
